(19) United States
(12) Patent Application Publication
(10) Pub. No.: US 2007/0240363 A1
(43) Pub. Date: Oct. 18, 2007

(54) Soil protector for potted plants

(76) Inventor: David E. Colletti, Kirkland, IL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/406,187

(22) Filed: Apr. 18, 2006

(51) Int. Cl. A01G 9/02

(52) U.S. Cl. 47/66.6

(57) ABSTRACT

A soil protector protects a potted plant from felines, other curious animals, and children. The plant grows from soil placed in a pot having an open top, with the plant having a stem extending upwardly from the soil. A soil protector is provided including a frustoconical member having an open bottom and an open top. The open bottom of the soil protector rests on the soil in the pot, and the plant grows up through the open top of the soil protector. The frustoconical member prevents access to the soil.

### TECHNICAL FIELD

The present invention generally relates to devices for maintaining potted plants, and, more particularly, relates to a soil protector for protecting the soil and roots of a potted plant from felines, other curious animals, and children.

### BACKGROUND OF THE INVENTION

It is generally appreciated that some animals enjoy eating and otherwise “playing” with house plants. Many domesticated animals, particularly cats, will chew on plant leaves or dig or urinate in the plant's soil or other growing medium. This is undesirable behavior, not only because it can harm the plant, but also because it may harm the pet.

Many plants are toxic to cats, and the toxic portion of the plant sometimes includes the roots. Thus, when a cat digs in the soil of a potted plant, it is not only harmful to the plant but also potentially harmful for the cat.

Young children may also find the soil for a potted plant to be fun to play with, possibly to the detriment of the plant.

In light of the foregoing, there exists a need in the art for a soil protector for a potted plant. A need exists to protect the soil from cats and other curious animals that might dig in the soil. With respect to cats, protecting the soil may be important to prevent the cat from being poisoned by accessing and chewing on the roots.

### SUMMARY OF THE INVENTION

The present invention provides a potted plant protected from felines and other curious animals. The plant grows from soil placed in a pot having an open top, with the plant having a stem extending upwardly from the soil. A soil protector is provided including a frustoconical member having an open bottom and an open top. The open bottom of the soil protector rests on the soil in the pot, and the plant grows up through the open top of the soil protector. The frustoconical member prevents access to the soil.

The frustoconical member is formed from a planar disc member having a hole at its center and a slit extending from the hole to the circumferential edge of the planar disc member. The slit defines first and second overlap members that can be overlapped to differing degrees and joined together to form frustoconical members of different sizes. The more the overlapped members are overlapped, the smaller the open bottom of the frustoconical member and the larger the height between the open bottom and the open top.

### BRIEF DESCRIPTION OF THE DRAWINGS

FIG. 1 is a side elevational view of a potted plant and soil protector combination in accordance with this invention;

FIG. 2 is a top plan view taken along the line 2-2 of FIG. 1;

FIG. 3 is a top plan view of a soil protector in accordance with this invention, shown before it has been formed into a frustoconical member;

FIG. 4 is a side elevational view of the soil protector of FIG. 3, shown with portions overlapped to create a frustoconical member of one size; and

FIG. 5 is a side elevational view of the soil protector of FIG. 3, shown with portions overlapped to create a frustoconical member of a different size.

### PREFERRED EMBODIMENT FOR CARRYING OUT THE INVENTION

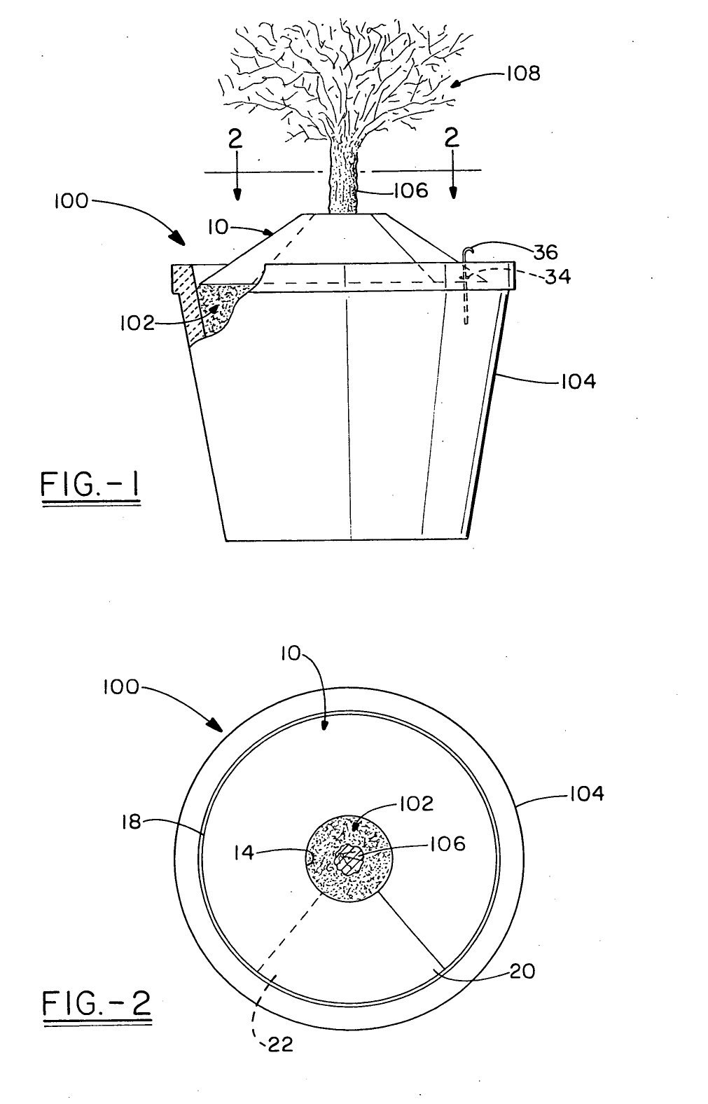

The present invention provides a soil protector for use in combination with a potted plant. The combination is shown in FIGS. 1 and 2, and designated by the numeral 100. The soil protector itself is shown alone in FIGS. 3-5 and designated by the numeral 10. From the combination of FIGS. 1 and 2, it can be seen that soil protector 10 rests on soil 102 in pot 104, with stem 106 of plant 108 extending through the open top of soil protector 10. This prevents access to soil 102.

Referring now to FIGS. 3-5, it can be seen that soil protector 10 is a planar disc member 12 having a hole 14 at its center, and a slit 16 extending from hole 14 to circumferential edge 18. Slit 16 thus defines first overlap member 20 and second overlap member 22, which are joined together to provide a frustoconical member, as seen in FIGS. 1, 4 and 5.

More particularly, first and second overlap members 20, 22 are joined together along a radial line extending from hole 14 to circumferential edge 18. They are joined by engaging at least one male protrusion 26 with a female port 28. In the embodiment shown, male protrusions 26 are provided on first overlap member 20, while female ports 28 are provided on second overlap member 22. More specifically, the embodiment shown includes female ports 28a, 28b and 28c and male protrusions 26a, 26b and 26c, and “female ports 28” and “male protrusions 26” refer collectively to those respective elements. It will be appreciated that the positioning of protrusions 26 and ports 28 could be switched. By overlapping first and second overlap members 20, 22, through the joinder of a male protrusion 26 with a female port 28, planar disc member 12 is formed into a frustoconical member 24. The size of frustoconical member 24, from its open top 30 to open bottom 32 is dictated by the extent of overlap of first and second overlap members 20, 22. Thus, in FIGS. 3-5, three sets of male protrusions are shown and three sets of female ports are shown, designated as male protrusions 26a, 26b and 26c and as female ports 28a, 28b, and 28c. More or less protrusions and ports can be provided as desired for achieving different sized frustoconical members. Male protrusions 26a and female ports 28a are each spaced at the same distance from slit 16 on their respective overlap member, and protrusions 26b and ports 28b are spaced at twice that distance, while protrusions 26c and 28c are spaced at three times that distance. By spacing the protrusions 26a, 26b and 26c and ports 28a, 28b and 28c in this manner, overlap members 20, 22 may be overlapped to differing degrees, and yet all sets of overlapping protrusions and ports will align for engagement.

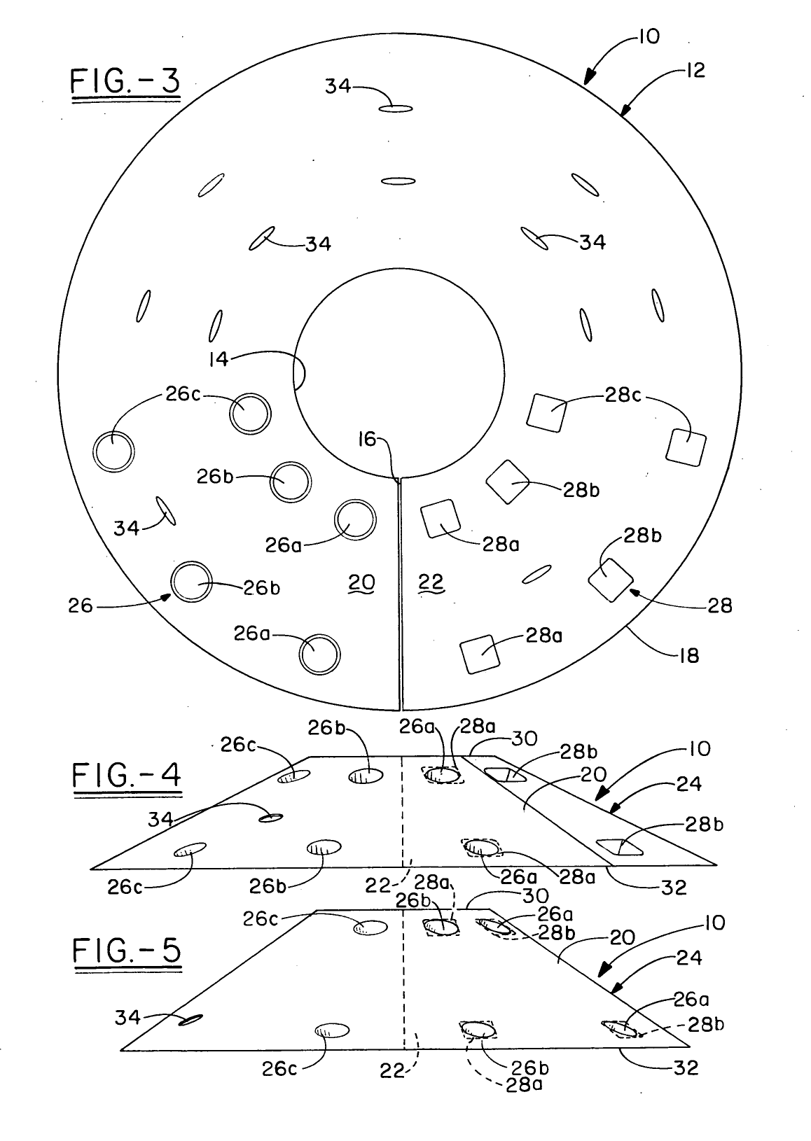

In FIG. 4, it can be seen that male protrusions 26a are engaged with female ports 28a. This creates a frustoconical member 24 with the largest possible open bottom 32 and with the shortest height from open bottom 32 to open top 30. In FIG. 5, male protrusions 26a engage female ports 28b, while male protrusions 26b engage female ports 28a, due to the identical spacing of the protrusions and ports from slit 16, as already described. Because the degree of overlap of first and second overlap members 20, 22 is greater, the frustoconical member 24 of FIG. 5 has a smaller open bottom 32 and a larger height from open bottom 32 to open top 30. It should be appreciated that first and second overlap members 20, 22 could be overlapped to even greater degrees by engaging male protrusions 26a with female ports 28c, male protrusions 26b with female ports 28b, and male protrusions 26c with female ports 28a.

As already discussed, the degree of overlap of overlap members 20, 22 dictates the size of frustoconical member 24. This is advantageous in that pots 104 might have differing diameters, such that a larger or smaller open bottom 32 is necessary to cover the soil 102 to the greatest extent possible.

Planar disc member 12 is preferably formed from a semi-rigid plastic material, being flexible enough to allow for the overlap of overlap members 20, 22 to form a frustoconical member. Sizes for planar disc member 12 and the number and placement of a plurality of ports 28 and protrusions 26 can be chosen according to the size of the plants and pots with which the soil protector is to be employed. Planar disc member 12 may be clear or colored as desired.

Soil protector 10 is used by first placing planar disc member 12 around the stem of a potted plant by passing the stem through slit 16 to reside in hole 14. First and second overlap members 20, 22 are then overlapped, and the appropriate protrusions 26 and ports 28 are joined to create a frustoconical member 24 having an open bottom 32 of a size that best covers the soil in the pot. At least one vent hole 34 may be provided in planar disc member 12 (frustoconical member 24 when so formed) to allow for proper ventilation and help prevent the soil from growing moldy. Vent hole 34 may receive a stake 36 that would help secure soil protector 10 within the pot.

Soil protector 10 can also help in growing plants from seeds, due to the greenhouse effect it creates.

In light of the foregoing, it should be evident that the present invention provides a new and useful soil protector for potted plants, and, substantially improves the art. While in accordance with the patent statutes only the preferred embodiments of the present invention have been described in detail hereinabove, the present invention is not to be limited thereto or thereby. The scope of the invention shall include all modifications and variations that fall within the scope of the attached claims.

What is claimed is:

1. A potted plant protected from felines and other curious critters comprising:
a pot having an open top;
soil in said pot;
a plant growing from soil, the plant having a stem extending up from said soil;
a soil protector including a frustoconical member having an open bottom and an open top, wherein said open bottom rests on said soil, with said plant growing up through said open top, said frustoconical member preventing access to said soil.

2. The potted plant of claim 1, wherein said frustoconical member is formed from a planar disc member having a hole at its center and a slit extending from said hole to the circumferential edge of said planar disc member, said slit defining first and second overlap members that are overlapped and joined together along a radial line extending from said hole to said circumference, said hole defining said open top and said circumference defining said open bottom.

3. The potted plant of claim 2, wherein said first overlap member includes at least one female port and said second overlap member includes at least one male protrusion, said at least one female port and at least one male protrusion being joined to join said first and second overlap members together along said radial line.

4. The potted plant of claim 3, wherein said at least one female port is provided by a first set of female ports radially aligned proximate said slit and a second set of female ports that are radially aligned and circumferentially spaced from said first set further away from said slit.

5. The potted plant of claim 4, wherein said at least one male protrusion is provided by a first set of male protrusions radially aligned proximate said slit and a second set of male protrusions that are radially aligned and circumferentially spaced from said first set of male protrusions.

6. The potted plant of claim 5, wherein said first set of female ports is circumferentially spaced from said second set of female ports at the same distance as said first set of male protrusions is circumferentially spaced from said second set of male protrusions.

7. The potted plant of claim 6, wherein said female ports are rectangular in cross section and said male protrusions are circular in cross section.

8. The potted plant of claim 1, wherein said planar disc member includes at least one stake down aperture.

9. The potted plant of claim 8, further comprising a stake extending through said at least one stake down aperture to secure said frustoconical member to said soil.

10. The potted plant of claim 1, including at least one ventilation hole.
